(19) United States
(12) Patent Application Publication
(10) Pub. No.: US 2026/0071653 A1
(43) Pub. Date: Mar. 12, 2026

(54) ROLLER BEARING

(71) Applicant: NTN CORPORATION, Osaka (JP)

(72) Inventors: Takeshi MAEDA, Mie (JP); Naofumi MIYAMOTO, Mie (JP)

(73) Assignee: NTN CORPORATION, Osaka (JP)

(21) Appl. No.: 19/100,342

(22) PCT Filed: Jul. 28, 2023
(86) PCT No.: PCT/JP2023/027764

§ 371 Date: Jan. 31, 2025

(30) Foreign Application Priority Data
Aug. 2, 2022 (JP) 2022-123189

(51) Int. Cl. F16C 33/46; F16C 19/26

(52) U.S. Cl. CPC F16C 33/467; F16C 19/26

(57) ABSTRACT

Pillars of a cage of a roller bearing are shaped to come into contact with rollers guiding the cage, on their anti-separation portions. In an imaginary plane orthogonal to the center axis of each roller, a contact angle defined by a first imaginary straight line connecting together a contact point between the roller and the pillar and the center axis, and a second imaginary straight line orthogonal to the radial direction and passing through the center axis is set to 20 to 24 degrees.

### TECHNICAL FIELD

The present invention relates to a roller bearing, particularly a roller bearing including a rolling element-guided type of cage.

### BACKGROUND ART

Roller bearings generally include an inner member having a raceway surface on the radially outer side; an outer member having a raceway surface on the radially inner side; a plurality of rollers disposed between the inner member and the outer member; and a cage retaining the rollers. The cage includes a plurality of pillars circumferentially equidistantly spaced apart from each other. The rollers are disposed between the respective circumferentially adjacent pairs of pillars. Each pillar has anti-separation portions disposed such that the anti-separation portions of each adjacent pair of pillars that are opposed to each other via the roller prevent the roller from falling off from between the adjacent pair of pillars. The cage is radially movable freely relative to the rollers within the range of pocket gaps. As a radially guided type of cage that exhibits run-out during rotation of such a bearing, a bearing ring-guided type of cage radially guided by the contact between the cage and a bearing ring constituting the inner member or the outer member, or a rolling element-guided type of cage radially guided by the contact between the rollers and the pillars is generally used.

If the roller bearing is used under the condition of high-speed rotation, e.g., used to support a main shaft of a machine tool, using the bearing ring-guided type of cage could cause heat generation due to the contact between the bearing ring and the cage, or could worsen discharge of lubricant by the bearing ring and a guiding surface of the cage. In order to avoid this, the rolling element-guided type of cage is used in the roller bearing that is used under the condition of high-speed rotation.

In the rolling element-guided type of cage, the contact portions of the pillars and the rollers guiding the cage are located on the cage radially inner side or the cage radially outer side of the center axes of the rollers. When the roller bearing is used under the condition that the inner member rotates and the outer member is stationary, if the contact portions of the pillars and the rollers guiding the cage are located on the cage radially inner side of the center axes of the rollers, it is known that the frictional forces at the contact portions of the rollers and the pillars increase, and the amount of heat generated increases (the below-identified Patent Document 1).

Also, it is known that due to a slight change in the positions of the contact portions of the pillars and the rollers guiding the cage, the frictional forces generated at the contact portions hinder the rollers from rotating about their center axes, and the rollers catch the pillars due to wedge effect, thereby causing a rise in the temperature of the roller bearing. As a countermeasure to hinder such a catching phenomenon, it has been proposed to set the contact angle between each roller guiding the cage and the pillar to 25 degrees or more and 35 degrees or less (the below-identified Patent Document 2).

### PRIOR ART DOCUMENT(S)

### Patent Document(s)

Patent Document 1: Japanese Unexamined Patent Application Publication No. 2000-274437

Patent Document 2: Japanese Unexamined Patent Application Publication No. 2006-242284

### SUMMARY OF THE INVENTION

### Problems to be Solved by the Invention

However, the roller bearing of Patent Document 2 is disadvantageous in that since the contact between the pillars and the rollers guiding the cage is allowed on the cage radially inner side of the center axes of the rollers, when the roller bearing is used under the condition that the inner member rotates at a high speed and the outer member is stationary, the frictional forces at the above contact portions are particularly large and the temperature is likely to rise.

In view of the above background, it is an object of the present invention to provide a roller bearing in which while reducing a rise in the temperature of the roller bearing when the roller bearing is used under the condition that an inner member having a raceway surface on the outer side rotates and an outer member having a raceway surface on the inner side is stationary, a roller can be easily inserted into the space between anti-separation portions of each adjacent pair of pillars of a rolling element-guided type of cage.

### Means for Solving the Problems

In order to achieve the above object, the present invention provides a first arrangement in which a roller bearing comprises: an inner member having a raceway surface on an outer side; an outer member having a raceway surface on an inner side; a plurality of rollers disposed between the inner member and the outer member; and a rolling element-guided type of cage retaining the rollers, wherein the cage includes a plurality of pillars circumferentially equidistantly spaced apart from each other, wherein the rollers are disposed between respective circumferentially adjacent pairs of the pillars, and wherein each of the pillars includes anti-separation portions disposed such that the anti-separation portions of each adjacent pair of the pillars that are opposed to each other via a corresponding one of the rollers prevent the corresponding one of the rollers from moving toward a cage radially outer side from between the adjacent pair of the pillars, characterized in that the pillars are shaped to come into contact with the rollers guiding the cage, on the anti-separation portions, wherein in an imaginary plane orthogonal to center axes of the rollers guiding the cage by contact with the pillars, a contact angle defined by a first imaginary straight line connecting together a contact point between each of the anti-separation portions of the pillars and the corresponding one of the rollers, and the center axis of the corresponding one of the rollers, and a second imaginary straight line which is orthogonal to a radial straight line passing through the center axis of the corresponding one of the rollers, and which passes through the center axis of the corresponding one of the rollers is set to 20 degrees or more and 24 degrees or less.

According to the first arrangement, since the pillars can come into contact with the rollers guiding the cage, on the anti-separation portions, which are located on the cage radially outer side of the center axes of the rollers, when the roller bearing is used under the condition that the inner member, which has a raceway surface (raceway surface of the inner member) on the outer side, rotates and the outer member, which has a raceway surface (raceway surface of the outer member) on the inner side is stationary, the forces acting on the pillars from the rollers at the contact portions of the rollers and the pillars act in a direction that contributes to the rotation of the cage. Therefore, it is possible to reduce the frictional forces at the contact portions of the rollers and the pillars, and reduce the amount of heat generated. Also, if the contact angles at the contact portions of the rollers guiding the cage and the pillars are 20 degrees or more, since the catching phenomenon is prevented, it is possible to reduce a rise in the temperature of the roller bearing. If the contact angles are 24 degrees or less, the distance between the opposed anti-separation portions of each adjacent pair of pillars is not too small compared to the diameter of the roller, so that it is possible to easily insert the roller into the space between the opposed anti-separation portions of each adjacent pair of pillars from the cage radially outer side.

In the first arrangement, a second arrangement may be used in which a distance between inner ends of each adjacent pair of the pillars opposed to each other via the corresponding one of the rollers, and located on a cage radially inner side of the center axis of the corresponding one of the rollers in the imaginary plane is larger than a diameter of the corresponding one of the rollers. According to the second arrangement, compared to a case where the distance between the opposed inner ends of each adjacent pair of pillars is smaller than the diameter of the roller, a lubricant can easily pass between each roller and the adjacent pillars, so that it is possible to reduce stirring resistance, and reduce a rise in the temperature of the roller bearing.

Also, in the first arrangement, a third arrangement may be used in which a distance between inner ends of each adjacent pair of the pillars opposed to each other via the corresponding one of the rollers, and located on a cage radially inner side of the center axis of the corresponding one of the rollers in the imaginary plane is smaller than a diameter of the corresponding one of the rollers. The third arrangement is disadvantageous in terms of reducing stirring resistance, but is advantageous in that the strength of the pillars is easily increased.

In any one of the first to third arrangements, a fourth arrangement may be used in which the inner member is integrally formed with: a first flange radially protruding on one axial side of the raceway surface of the inner member; and a second flange radially protruding on the other axial side of the raceway surface of the inner member, and the cage is integrally formed with: a first ring continuous with one axial side of the pillars; and a second ring continuous with the other axial side of the pillars. With the fourth arrangement, it is possible to assemble the inner member, the cage and the rollers into an assembly, while forming each of the cage and the inner member as a single member, thereby reducing the cost.

In any one of the first to fourth arrangements, a fifth arrangement may be used in which the cage is formed by injection molding. Since, as described above, an allowable angle range of 20 to 24 degrees is set as the contact angle, accuracy control for machining the anti-separation portions of the pillars is not required. Therefore, by forming the case by injection molding as in the fifth arrangement, compared to a machined cage, it is possible to reduce the weight and improve the high-speed performance, and also to reduce the cost of manufacturing the cage.

### Effects of the Invention

According to the present invention, since the first arrangement is used, while reducing a rise in the temperature of the roller bearing when the roller bearing is used under the condition that an inner member having a raceway surface on the outer side rotates and an outer member having a raceway surface on the inner side is stationary, it is possible to easily insert a roller into the space between anti-separation portions of each adjacent pair of pillars of the rolling element-guided type of cage.

### BRIEF DESCRIPTION OF THE DRAWINGS

FIG. 1 is a sectional view of a roller baring according to a first embodiment of the present invention as an example.

FIG. 2 is a sectional view taken along line I-I of FIG. 1.

FIG. 3 is a sectional view illustrating pillars according to a second embodiment of the present invention.

### BEST MODE FOR CARRYING OUT THE INVENTION

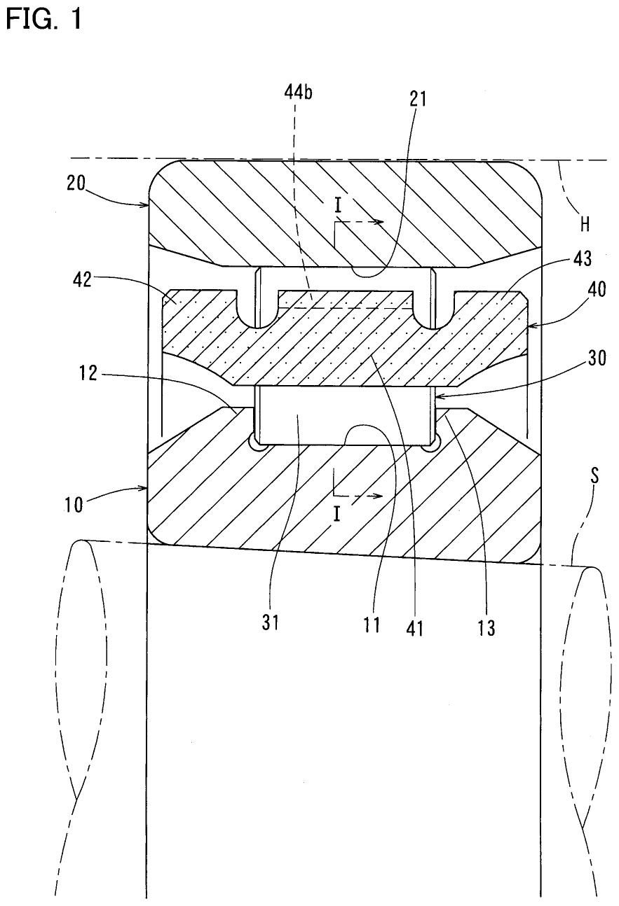

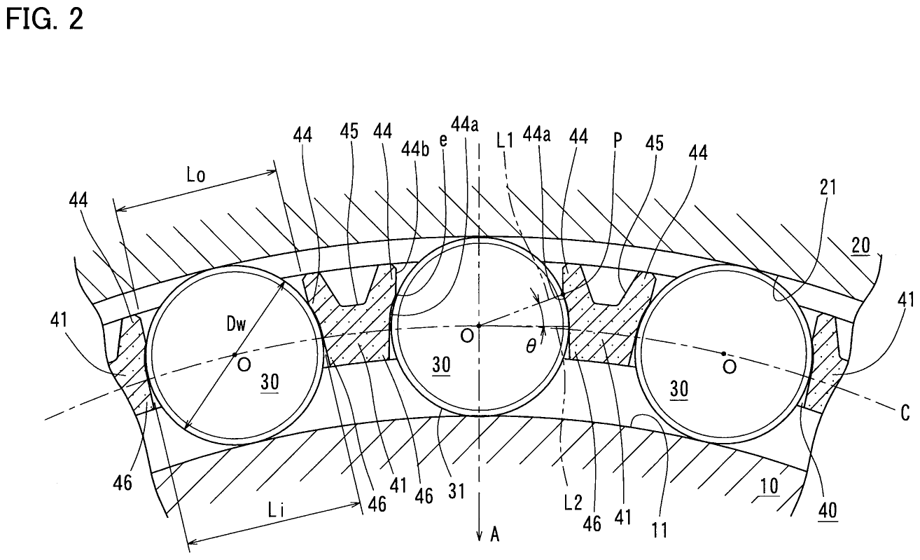

A roller bearing according to a first embodiment of the present invention is now described with reference to FIGS. 1 and 2 of the attached drawings.

The roller bearing illustrated in FIGS. 1 and 2 includes an inner member 10 having a raceway surface 11 (raceway surface of the inner member) on the outer side; an outer member 20 having a raceway surface 21 (raceway surface of the outer member) on the inner side; a plurality of rollers 30 disposed between the raceway surface 11 of the inner member 10 and the raceway surface 21 of the outer member 20; and a cage 40 retaining the rollers 30.

FIG. 1 illustrates a cross section in an imaginary plane orthogonal to the central axes of the cage 40 and the rollers 30. FIG. 2 illustrates a state in which the inner member 10, the outer member 20 and the cage 40 are arranged coaxially to have a common center axis (not shown). As used herein, the terms “axial” and “axially” refer to the direction along the common center axis; the terms “radial” and “radially” refer to a direction orthogonal to the common center axis; and the terms “circumferential” and “circumferentially” refer to the direction around the common center axis.

The inner member 10 is constituted as a single bearing ring integrally formed with a first flange 12 disposed on the outer periphery thereof so as to radially protrude on one axial side of the raceway surface 11; and a second flange 13 disposed on the outer periphery thereof so as to radially protrude on the other axial side of the raceway surface 11. The outer member 20 is constituted as a single bearing ring having a raceway surface 21 on the inner periphery thereof. The raceway surface 11 on the outer side and the raceway surface 21 on the inner side are formed as cylindrical surfaces extending in the circumferential direction. The outer member 20 includes, on its inner periphery, no portion that radially protrudes further than the raceway surface 21. This roller bearing is a separable roller bearing in which the outer member 20 is axially separable from the assembly of the inner member 10, the cage 40 and the rollers 30.

The inner member 10 is attached to a shaft S. The outer member 20 is attached to a housing H which is stationary relative to the shaft S. The inner member 10 rotates in unison with the shaft S. The outer member 20 is radially supported by the housing H. The shaft S is, e.g., a main shaft of a machine tool. As a lubrication method for the roller bearing used in such a high-speed rotation environment, for example, there is oil air lubrication, oil mist lubrication or jet lubrication.

Each roller 30 has a rolling surface 31 that rolls on the raceway surfaces 11 and 21 on the outer and inner sides, and the rolling surface 31 is formed as a cylindrical surface.

The cage 40 is constituted as a single annulus integrally formed with a plurality of pillars 41 circumferentially equidistantly spaced apart from each other; a first ring 42 continuous with one axial side of the pillars 41; and a second ring 43 continuous with the other axial side of the pillars 41. The entire cage 40 is shaped to have n-fold rotational symmetry in the circumferential direction.

The rollers 30 are disposed between the respective circumferentially adjacent pairs of pillars 41. A pocket that is a space for receiving each roller 30 in the cage 40 is defined to have a basket shape by the adjacent pair of pillars 41, the first ring 42 and the second ring 43.

The entire age 40 is a seamless cage formed by injection molding. A synthetic resin is used as the material forming the cage 40. The synthetic resin refers to a composition including, as its main component, a polymer such as polyamide (PA), polyether ether ketone (PEEK) or polyphenylene sulfide (PPS), and the composition may include, as its secondary component, glass fiber, carbon fiber or a modifier as necessary.

As illustrated in FIG. 2, each pillar 41 includes a pair of anti-separation portions 44 disposed such that the anti-separation portions 44 of each adjacent pair of pillars 41 that are opposed to each other via the roller 30 (hereinafter referred to as “the opposed anti-separation portions 44 of each/the adjacent pair of pillars 41”) prevent the roller 30 from moving toward the cage radially outer side from between the adjacent pair of pillars 41. The anti-separation portions 44 of the pillars 41 are portions of the pillars 41 located on the cage radially outer side of an imaginary tubular surface C including the center axes O of the rollers 30. The distance Lo between the opposed anti-separation portions 44 of each adjacent pair of pillars 41 is smaller than the diameter Dw of the roller 30.

When considering an imaginary circle (circumcircle) coaxial with the cage 40 and circumscribed around the cage 40 and an imaginary circle (incircle) coaxial with the cage 40 and inscribed in the cage 40 in an imaginary plane orthogonal to the center axis of the cage 40, the side toward the circumcircle in the radial direction is referred to as the cage radially outer side, and the opposite side, i.e., the side toward the incircle in the radial direction is referred to as the cage radially inner side.

Each anti-separation portion 44 has a curved pocket surface 44a that can come into contact with the roller 30 circumferentially and radially; and an end surface 44b extending such that the circumferential distance between the end surface 44b and the roller 30 gradually increases compared to the end e of the pocket surface 44a on the cage radially outer side.

Each pillar 41 has the pair of anti-separation portions 44 on both circumferential sides thereof, and the pair of anti-separation portions 44 are arranged to be symmetrical to each other in the circumferential direction relative to a radial cross section passing through the circumferential center of the pillar 41. When forming the cage 40 by injection molding, a mold for forming the circumferentially opposed surfaces of each adjacent pair of pillars 41 is forcibly removed from between the adjacent pair of pillars 41 toward the cage radially outer side.

By pushing the roller 30 into the space between the opposed anti-separation portions 44 of each adjacent pair of pillars 41 from the cage radially outer side, and forcing the roller 30 to pass through this space, the roller 30 is inserted into the space between the flanges 12 and 13 of the inner member 10. By inserting the rollers 30 into the spaces between the adjacent pairs of pillars 41 as described above, the inner member 10, the cage 40 and the rollers 30 are assembled into an assembly.

Each end surface 44b of each pillar 41 comprises a flat surface portion extending from the end e of the pocket surface 44a on the cage radially outer side; and a tapered surface portion extending from the flat surface portion. The tapered surface portion of each end surface 44b of each adjacent pair of pillars 41 allows the roller 30 to be pushed easily into the space between the opposed anti-separation portions 44 of the adjacent pair of pillars 41 from the cage radially outer side.

Each pillar 41 has a groove 45 axially extending between the anti-separation portions 44 on both circumferential sides thereof. The groove 45 is open to the outer periphery of the cage 40, and the bottom of the groove 45 is located on the cage radially inner side of the ends e of the pocket surfaces 44a on the cage radially outer side. The grooves 45 of each adjacent pair of pillars 41 also allow the roller 30 to be pushed easily into the space between the opposed anti-separation portions 44 of the adjacent pair of pillars 41 from the cage radially outer side. The bottom of the groove 45 of each pillar 41 may be located on the cage radially outer side of the ends e of the pocket surfaces 44a on the cage radially outer side.

The outer end portion of each anti-separation portion 44 having the end surface 44b is a protrusion axially separated from the first ring 42 and the second ring 43. Since the outer end portions of the anti-separation portions 44 of the pillars 41 are axially separated from the first ring 42 and the second ring 43, it is possible to easily push each roller 30 into the space between the opposed anti-separation portions 44 of the adjacent pair of pillars 41 from the cage radially outer side.

A pocket gap is defined between each adjacent pair of pillars 41, the first and second rings 42 and 43, and the roller 30. The cage 40 is radially movable freely relative to the rollers 30 within the range of the pocket gaps between the adjacent pairs of pillars 41 and the respective rollers 30.

The cage 40 is a rolling element-guided type of cage radially guided by the rollers 30. That is, the radial gap between the cage 40 and the inner member 10 and the radial gap between the cage 40 and the outer member 20 are each larger than the amount by which the cage 40 is radially movable freely based on the above pocket gaps. When the cage 40 radially moves relative to the inner member 10 and the outer member 20, the cage 40 is radially guided by the contact between the rolling surfaces 31 of the rollers 30 and the anti-separation portions 44 of the pillars 41 before the cage 40 comes into contact with the inner member 10 or the outer member 20 in the radial direction.

FIG. 2 illustrates a state in which the cage 40 has radially moved to the limit, the center axis O of the roller 30 at the center in FIG. 2 is located circumferentially 180 degrees opposite to the movement direction A of the cage 40, and the cage 40 is guided by the roller 30 in contact with the anti-separation portions 44 of the pillars 41 in the movement direction A.

The distance Li between the inner ends 46 of each adjacent pair of pillars 41 opposed to each other via the roller 30, and located on the cage radially inner side of the center axis O of the roller 30 in an imaginary plane orthogonal to the center axis O of the roller 30 is larger than the diameter Dw of the roller 30. The gap between each inner end 46 of each pillar 41 and the roller 30 is larger than the pocket gap between the roller 30 and the pocket surface 44a. That is, the pillars 41 are shaped to come into contact with the rollers 30 guiding the cage 40, on the pocket surfaces 44a of the anti-separation portions 44.

During rotation of the inner member 10, the contact portions of the roller 30 that drives the cage 40 and the anti-separation portions 44 of the pillars 41 in a load receiving area of the roller bearing are located on the cage radially outer side of the center axis O of the roller 30. Therefore, due to the force acting on the cage 40 from the driving roller 30, the rollers 30 that do not drive the cage 40 (non-driving rollers 30) are pushed against the raceway surface 11 without being pushed against the stationary raceway surface 21. The non-driving rollers 30 actively start to rotate about their center axes by being pushed against the raceway surface 11. Or, even if the rotation of the non-driving rollers 30 about their center axes is braked by pushing the non-driving rollers 30 against the raceway surface 11, the non-driving rollers 30 revolve around the shaft S together with the rotating raceway surface 11 (at approximately twice the normal rolling speed). In any case, the frictional forces at the contact portions of the non-driving rollers 30 and the anti-separation portions 44 of the pillars 41 act in a direction that contributes to the rotation of the cage 40.

If the rollers guiding the cage and the pillars come into contact with each other on the cage radially inner side of the center axes of the rollers, the forces acting on the pillars from the roller driving the cage will act to push the non-driving rollers against the raceway surface of the stationary outer member. Therefore, the rotation of the non-driving rollers about their center axes will be strongly braked, and a braking force in the direction opposite from the rotation of the cage will act on the pillars from the non-driving rollers, thereby increasing the frictional forces at the contact portions of the rollers and the pillars.

In an imaginary plane orthogonal to the center axes O of the rollers 30 guiding the cage 40 by the contact with the anti-separation portions 44 of the pillars 41, a contact angle θ defined by a first imaginary straight line L1 connecting together a contact point P between each roller 30 and each of the opposed anti-separation portions 44 of the corresponding adjacent pillars 41 and the center axis O of the roller 30, and a second imaginary straight line L2 orthogonal to the radial direction and passing through the center axis O of the roller 30 is set within a predetermined angle range.

The frictional force generated at the contact point P decreases as the contact angle θ increases, and this frictional force increases as the contact angle θ decreases. Therefore, the smaller the contact angle θ is, the larger the frictional force generated at the contact point P is, so that the rotation of the rollers 30 about their center axes is hindered, and the rollers 30 are likely to catch the pocket surfaces 44a of the pillars 41 (such a phenomenon is hereinafter referred to as “the catching phenomenon”). Therefore, the minimum value of the contact angle θ is set to 20 degrees. Due to this, the frictional force generated at the contact point P does not increase excessively and the rotation of the rollers 30 about their center axes is less likely to be hindered, so that the catching phenomenon is prevented.

During normal operation in which the inner member 10 rotates, and the rollers 30 revolve around the shaft S while rotating about their center axes between the raceway surfaces 11 and 21 on the outer and inner sides, the lubrication mode at the contact portions of the rollers 30 and the anti-separation portions 44 of the pillars 41 is a mixed lubrication state (friction coefficient 0.005 to 0.1) or a fluid lubrication state (friction coefficient 0.001 to 0.005). In case of high-speed rotation and especially a thin lubrication environment, the lubrication mode may become a boundary lubrication state (friction coefficient 0.1 to 0.3) due to insufficient oil supply to the contact portions. The friction forces at the contact portions in the boundary lubrication state are particularly large, and the catching phenomenon is likely to occur. Therefore, by setting the minimum value of the contact angle O such that in the boundary lubrication state (friction coefficient 0.3), the rotation of the rollers 30 about their center axes does not stop due to the frictional forces at the contact portions, it is possible to effectively prevent the catching phenomenon.

On the other hand, if the maximum value of the contact angle θ is too large, the distance Lo between the opposed anti-separation portions 44 of each adjacent pair of pillars 41 will be too small compared to the diameter Dw of the roller 30, so that it will be very difficult to forcibly insert the roller 30 into the space between the opposed anti-separation portions 44 of each adjacent pair of pillars 41 from the cage radially outer side as described above. Therefore, the maximum value of the contact angle θ is set to 24 degrees. Due to this, the distance Lo between the opposed anti-separation portions 44 of each adjacent pair of pillars 41 is not too small, so that it is possible to facilitate insertion of the roller 30 into the space between the opposed anti-separation portions 44 of each adjacent pair of pillars 41 from the cage radially outer side to such an extent that this step can be practically carried out.

The position of the contact point P when the contact angle θ is 24 degrees is preferably set on the end e of the pocket surface 44a of the pillar 41 on the cage radially outer side (inflection point at the boundary between the pocket surface 44a and the end surface 44b). Compared to a case where the end surfaces 44b of the pillars 41 are omitted and the pocket surfaces 44a further extend toward the cage radially outer side, this arrangement is advantageous in that the distance Lo between the opposed anti-separation portions 44 of each adjacent pair of pillars 41 is relatively large, and the end surfaces 44b are formed, so that the roller 30 can be easily inserted into the space between the opposed anti-separation portions 44 of the adjacent pair of pillars 41.

As described above, the roller bearing illustrated in FIGS. 1 and 2 includes an inner member 10 having a raceway surface 11 on the outer side; an outer member 20 having a raceway surface 21 on the inner side; a plurality of rollers 30 disposed between the inner member 10 and the outer member 20; and a cage 40 comprising a rolling element-guided type of cage, and retaining the rollers 30, the cage 40 includes a plurality of pillars 41 circumferentially equidistantly spaced apart from each other, the rollers 30 are disposed between the respective circumferentially adjacent pairs of pillars 41, and each pillar 41 includes a pair of anti-separation portions 44 disposed such that the anti-separation portions 44 of each adjacent pair of pillars 41 that are opposed to each other via the roller 30 prevent the roller 30 from moving toward the cage radially outer side from between the adjacent pair of pillars 41.

Especially with respect to this roller bearing, since the pillars 41 are shaped to come into contact with the rollers 30 guiding the cage 40, on the pocket surfaces 44a of the anti-separation portions 44, when the roller bearing is used under the condition that the inner member 10 rotates and the outer member 20 is stationary, the forces acting on the pillars 41 from the rollers 30 at the contact portions of the rollers 30 and the pillars 41 act in a direction that contributes to the rotation of the cage 40. Therefore, compared to a case where the cage is guided on the cage radially inner side of the center axes of the rollers, the frictional forces at the contact portions of the rollers 30 and the pillars 41 can be made relatively small, and the amount of heat generated can be reduced.

Also, with respect to this roller bearing, since in an imaginary plane orthogonal to the center axes O of the rollers 30 guiding the cage 40 by the contact with the pillars 41, a contact angle θ defined by a first imaginary straight line L1 connecting together a contact point P between each roller 30 and the corresponding pillar 41 and the center axis O of the roller 30, and a second imaginary straight line L2 orthogonal to the radial direction and passing through the center axis O of the roller 30 is set to 20 degrees or more, the rollers 30 are prevented from catching the anti-separation portions 44. Due to this, too, it is possible to reduce a rise in the temperature of the roller bearing when the roller bearing is used under the condition that the inner member 10 rotates and the outer member 20 is stationary.

Also, with respect to this roller bearing, since the contact angle θ is set to 24 degrees or less, the distance Lo between the opposed anti-separation portions 44 of each adjacent pair of pillars 41 is not too small compared to the diameter Dw of the roller 30, so that it is possible to easily insert the roller 30 into the space between the opposed anti-separation portions 44 of each adjacent pair of pillars 41 from the cage radially outer side.

As described above, with respect to this roller bearing, while reducing a rise in the temperature of the roller bearing when the roller bearing is used under the condition that the inner member 10, which has a raceway surface 11 on the outer side, rotates and the outer member 20, which has a raceway surface 21 on the inner side, is stationary, it is possible to easily insert the roller 30 into the space between the opposed anti-separation portions 44 of each adjacent pair of pillars 41 of the rolling element-guided type of cage 40.

Also, with respect to this roller bearing, the distance Li between the inner ends 46 of each adjacent pair of pillars 41 opposed to each other via the roller 30, and located on the cage radially inner side of the center axis O of the roller 30 in the above imaginary plane is larger than the diameter Dw of the roller 30. Therefore, compared to a case where the distance Li is smaller than the diameter Dw of the roller 30, a lubricant can easily pass between the rolling surface 31 of each roller 30 and the adjacent pillars 41 from the cage radially inner side to the cage radially outer side during rotation of the bearing, so that it is possible to reduce stirring resistance, and reduce a rise in the temperature of the roller bearing.

Also, with respect to this roller bearing, the inner member 10 is integrally formed with a first flange 12 radially protruding on one axial side of the raceway surface 11; and a second flange 13 radially protruding on the other axial side of the raceway surface 11, and the cage 40 is integrally formed with a first ring 42 continuous with one axial side of the pillars 41; and a second ring 43 continuous with the other axial side of the pillars 41. Therefore, compared to a case where rings and flanges are constituted as separate components in order to omit the step of pushing in the rollers 30, it is possible to assemble the inner member 10, the cage 40 and the rollers 30 into an assembly, while forming each of the cage 40 and the inner member 10 as a single member, thereby reducing the cost.

Also, with respect to this roller bearing, the cage 40 is formed by injection molding of a synthetic resin. Therefore, compared to a machined cage, it is possible to reduce the weight and improve the high-speed performance, and also to reduce the cost of manufacturing the cage.

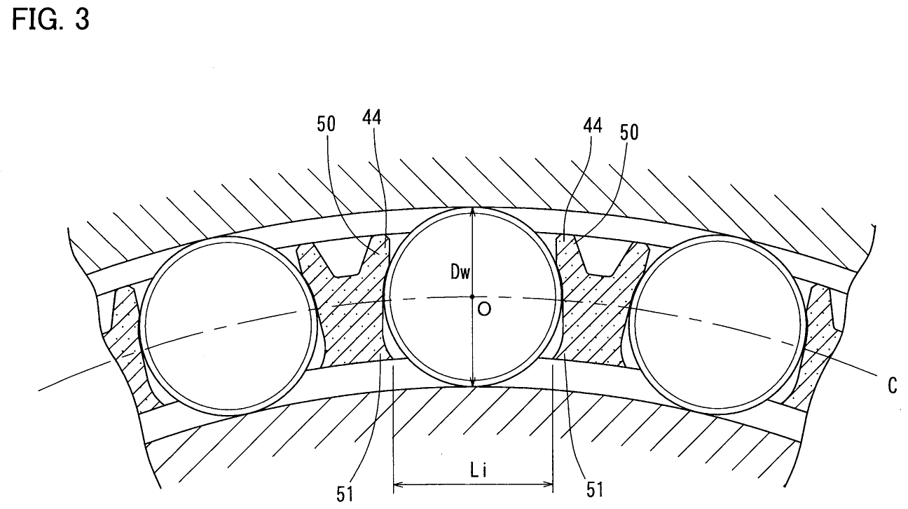

FIG. 3 illustrates a second embodiment of the present invention. Only the features of the second embodiment that are different from those of the first embodiment are described below.

The pillars 50 of the second embodiment further extend toward the cage radially inner side compared to the first embodiment. The distance Li between the inner ends 51 of each circumferentially adjacent pair of pillars 50 opposed to each other via the roller 30, and located on the cage radially inner side of the center axis O of the roller 30 in an imaginary plane orthogonal to the center axis O of the roller 30 is smaller than the diameter Dw of the roller 30. The second embodiment is the same as the first embodiment in that the rollers 30 cannot come into contact with the inner ends 51 of the pillars 50, but the distance Li between the opposed inner ends 51 of each circumferentially adjacent pair of pillars 50 and the roller 30 is smaller than in the first embodiment. Therefore, during rotation of the roller bearing, a lubricant is relatively less likely to pass between each roller 30 and the adjacent pillars 50 from the cage radially inner side to the cage radially outer side. Therefore, the roller bearing of the second embodiment is disadvantageous in terms of reducing the stirring resistance of lubricant, but is advantageous in that the cross-sectional areas of the pillars 50 are increased, thereby easily increasing the strength of the pillars 50.

The above-described embodiments are mere examples in every respect, and the present invention is not limited thereto. Therefore, the scope of the present invention is indicated by the claims, and should be understood to include all modifications within the meaning and scope equivalent to the scope of the claims.

### DESCRIPTION OF REFERENCE NUMERALS

10: Inner member
11: Raceway surface (raceway surface of the inner member)
12: First flange
13: Second flange
20: Outer member
21: Raceway surface (raceway surface of the outer member)
30: Roller
40: Cage
41, 50: Pillar
42: First ring
43: Second ring
44: Anti-separation portion
46, 51: Inner end

1. A roller bearing comprising:
an inner member having a raceway surface on an outer side;
an outer member having a raceway surface on an inner side;
a plurality of rollers disposed between the inner member and the outer member; and
a rolling element-guided type of cage retaining the rollers,
wherein the cage includes a plurality of pillars circumferentially equidistantly spaced apart from each other,
wherein the rollers are disposed between respective circumferentially adjacent pairs of the pillars,
wherein each of the pillars includes anti-separation portions disposed such that the anti-separation portions of each adjacent pair of the pillars that are opposed to each other via a corresponding one of the rollers prevent the corresponding one of the rollers from moving toward a cage radially outer side from between the adjacent pair of the pillars,
wherein the pillars are shaped to come into contact with the rollers guiding the cage, on the anti-separation portions, and
wherein in an imaginary plane orthogonal to center axes of the rollers guiding the cage by contact with the pillars, a contact angle defined by a first imaginary straight line connecting together a contact point between each of the anti-separation portions of the pillars and the corresponding one of the rollers, and the center axis of the corresponding one of the rollers, and a second imaginary straight line which is orthogonal to a radial straight line passing through the center axis of the corresponding one of the rollers, and which passes through the center axis of the corresponding one of the rollers is set to 20 degrees or more and 24 degrees or less.

2. The roller bearing according to claim 1, wherein a distance between inner ends of each adjacent pair of the pillars opposed to each other via the corresponding one of the rollers, and located on a cage radially inner side of the center axis of the corresponding one of the rollers in the imaginary plane is larger than a diameter of the corresponding one of the rollers.

3. The roller bearing according to claim 1, wherein a distance between inner ends of each adjacent pair of the pillars opposed to each other via the corresponding one of the rollers, and located on a cage radially inner side of the center axis of the corresponding one of the rollers in the imaginary plane is smaller than a diameter of the corresponding one of the rollers.

4. The roller bearing according to claim 1, wherein the inner member is integrally formed with:
a first flange radially protruding on one axial side of the raceway surface of the inner member; and
a second flange radially protruding on the other axial side of the raceway surface of the inner member, and
wherein the cage is integrally formed with:
a first ring continuous with one axial side of the pillars; and
a second ring continuous with the other axial side of the pillars.

5. The roller bearing according claim 1, wherein the cage is formed by injection molding.

6. The roller bearing according to claim 2, wherein the inner member is integrally formed with:
a first flange radially protruding on one axial side of the raceway surface of the inner member; and
a second flange radially protruding on the other axial side of the raceway surface of the inner member, and
wherein the cage is integrally formed with:
a first ring continuous with one axial side of the pillars; and
a second ring continuous with the other axial side of the pillars.

7. The roller bearing according to claim 2, wherein the cage is formed by injection molding.

8. The roller bearing according to claim 3, wherein the inner member is integrally formed with:
a first flange radially protruding on one axial side of the raceway surface of the inner member; and
a second flange radially protruding on the other axial side of the raceway surface of the inner member, and
wherein the cage is integrally formed with:
a first ring continuous with one axial side of the pillars; and
a second ring continuous with the other axial side of the pillars.

9. The roller bearing according to claim 3, wherein the cage is formed by injection molding.

10. The roller bearing according to claim 4, wherein the cage is formed by injection molding.

11. The roller bearing according to claim 6, wherein the cage is formed by injection molding.

12. The roller bearing according to claim 8, wherein the cage is formed by injection molding.
